(19) United States
(12) Patent Application Publication
(10) Pub. No.: US 2006/0231646 A1
(43) Pub. Date: Oct. 19, 2006

(54) Straight flow nozzle

(76) Inventor: Charles T. Geary JR., Pocono Lake, PA (US)

Correspondence Address: Graham, Curtin & Sheridan;A Professional Association, 4 Headquarters Plaza, P.O. Box 1991, Morristown, NJ, 07962-1991, US

(21) Appl. No.: 11/106,861

(22) Filed: Apr. 18, 2005

(51) Int. Cl. B05B 9/08; B05B 1/30

(52) U.S. Cl. 239/530; 239/583

(57) ABSTRACT

A straight flow nozzle is provided having a housing through which fluid flows in a straight line, the housing having two opposite ends, one of said ends having a discharge port open to the ambient atmosphere for discharge of the fluid, a coupling means secured to the other end for coupling a source of pressurized fluid to the housing, a valve seat located adjacent to the discharge end of the housing, valve closure means operating in combination with the valve seat, the valve closure means being forced into a closed position by the force of the fluid flow through the housing which prevents the flow of fluid out of the discharge port, and control means for opening and closing the valve closure means.

This invention relates generally to fluid spray nozzles, and more particularly, to a commercial nozzle for spraying liquids, such as water, in different stream patterns.

### BACKGROUND OF THE INVENTION

Spray nozzles for water or other fluids generally comprise a barrel having an axially movable valve for generating different spray patterns. The nozzle may include an adjustable pattern inducing projection in the path of the stream for causing the stream to vary, such as from a coarse to a fine stream. A stem is connected to the valve and projects beyond the barrel at the barrel rear to receive the flow of fluid.

Some garden hose nozzles also include a by-pass attachment to and extending from the barrel to mix materials with the flow of water, such as fertilizer.

U.S. Pat. No. 2,129,511 issued Sep. 6, 1938 to E.H. Tompkins, et al., is of interest and is directed to a gas pump nozzle which has a straight flow design. Such a nozzle is designed for a high volume of pass through of liquids and the quantity of liquid is controlled by a valve which has variable degrees of opening which creates turbulence in the stream. It is believed that this type of design is remote from the invention defined herein.

It is desirable to have a nozzle which allows the fluid to flow through the housing in an uninterrupted path so that there is no dissipation of the maximum obtainable volume.

### SUMMARY OF THE INVENTION

An object of this invention is to provide a straight through design of a nozzle allowing water and/or a water solution to flow through the nozzle undergoing less turbulence.

Another object of the invention is to provide a nozzle with less contamination.

A still further object is to provide a nozzle with a seal on the pressure side of the seat so that pressure acts to force the closure of the seal.

Another object of the invention is to provide a nozzle with less flow-resistance.

Another object of the invention is to provide a nozzle with a smaller silhouette.

Another object of the invention is to provide such a nozzle in which the flow path does not have sharp turns which would reduce the velocity.

Another object of the invention is to provide a nozzle with improved drainability.

A still further object of the invention is to provide a nozzle which is readily cleanable.

Another object of the invention is to provide such a nozzle which is inexpensive to produce and is reliable in operation.

Another object of the invention is to provide such a nozzle which has as few moving parts and chambers.

Another object of the invention is to provide a nozzle which allows easy changeability of discharge nozzle heads.

These and other objects and the advantages of the invention will be apparent from the following descriptions.

In accordance with the invention, generally stated, a straight flow nozzle is provided having a housing through which fluid flows in a straight line. The housing is preferably a cylinder made of stainless steel. The housing has two opposite ends. One of the ends is a discharge port open to the ambient atmosphere for discharge of the fluid from the nozzle. A coupling means is secured to the other end of the housing for coupling to the housing a pressurized supply of fluid.

The nozzle has an associated valve assembly means of novel construction . The valve assembly has a valve seat located adjacent to the discharge end of the housing. A valve closure means is provided for operating in combination with the valve seat. The valve closure means is located so that it is maintained in a closed position by the force of the pressurized fluid in the housing which prevents the flow of fluid out of the discharge port.

Control means is provided for opening the valve. The control means is located on the outer side of the housing. A handle is provided which when pressed downward towards the housing opens the valve closure to allow fluid to flow out of the housing. The handled has a fulcrum point on the housing where it is secured to allow downward movement. A curved arm is affixed to the short end of the handle which extends through the housing and connects to an extension arm of the closure. The extension arm of the closure extends from the closure along the center axis of the housing. The extension has a slot in its end which allows the curved arm to pass through the extension and securing means for maintaining the curved rod in contact with the extension rod affixed to the valve closure. When the handle is pressed downward it causes the extension arm to move laterally and open the valve assembly to allow the passage of fluid out of the housing through the discharge port.

### BRIEF DESCRIPTION OF THE DRAWINGS

FIG. 1 is a perspective sectional view of one illustrative embodiment of the invention.

FIG. 2 is a view taken along lines A A' shown in FIG. 1.

FIG. 3 is an end view partly in section of the front support.

FIG. 4 is an end view partly in section of the back support.

FIG. 5 is sectional view as shown in FIG. 1 wherein the control means is shown in the open position.

FIG. 6 is a view taken along lines B B' shown in FIG. 3.

FIG. 7 are illustrations of various attachments which can be fitted to the discharge port shown in FIGS. 1 and 5.

### DETAILED DESCRIPTION OF THE PREFERRED EMBODIMENT

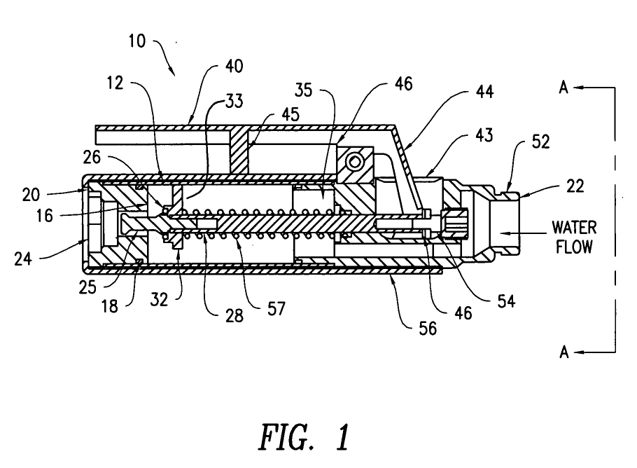

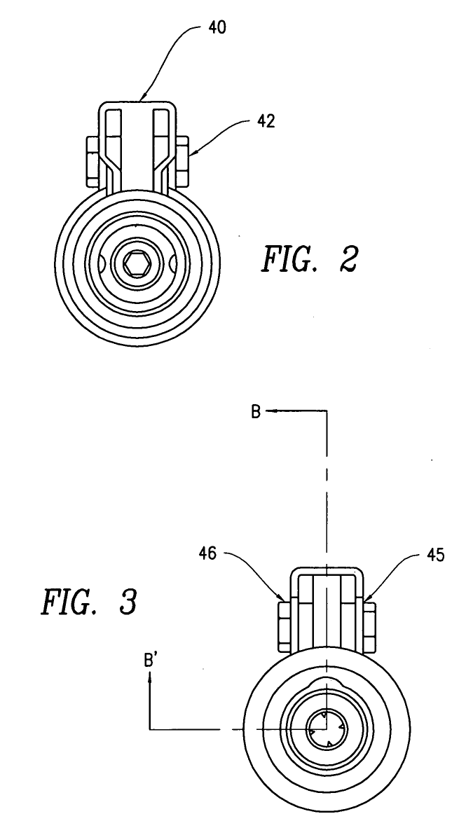

Referring to FIGS. 1 to 5, in accordance with the invention, a nozzle, generally indicated at 10, is provided having a straight fluid flow design allowing fluid to flow through the nozzle with limited turbulence. The nozzle has a housing 12, preferably in the form of a tube with a hollow core and a horizontal axis, through which fluid flows. The flow of fluid is indicated by a series of arrows on FIG. 1.

The housing has two opposite ends 20, 22. One of the ends 20 is a discharge port 24 open to the ambient atmosphere for discharge of the fluid from the nozzle. A coupling means 52 secured to the opposite end 22 of the housing 12 for coupling to the housing, not shown, a source of pressurized fluid such as a hose or other suitable delivery systems.

A fluid control valve assembly 25 is disposed in the discharge end 20 of the housing 12 . The assembly comprises a circular metal, preferably stainless steel, valve seat member 16 closely received in and retained in the bore of the housing 12 by “O” retaining ring 18 which mates in a groove in the housing bore. The member is sealed to the housing to prevent free passage of fluid.

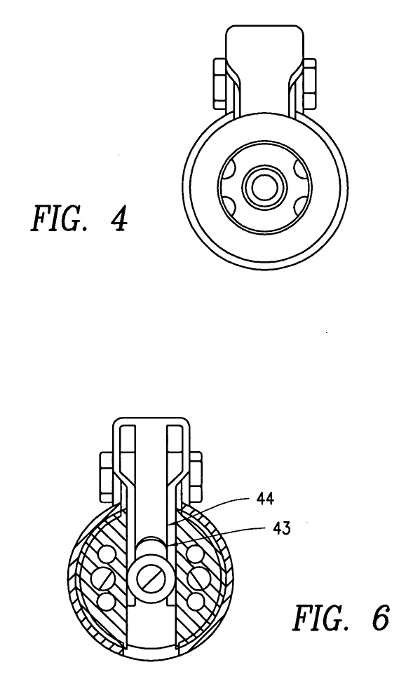

FIGS. 3 and 4 show the construction of the inserts in the housing in which the connecting rod is journal and allow the passage of fluid. Both inserts have a clear passage for the water.

The valve seat 16 is substantially conical and located adjacent to the discharge end 20 of the housing 12 for receiving the valve closure means 26. Preferably, the valve closing means or seal is a resilient, durable material, such as synthetic rubber, and has a sloped or slanted peripheral outer edge to conform to the conically-shaped valve seat providing self-cleaning, sealing arrangement closure.

The valve closure means 26 operates in combination with the valve seat 16. The valve closure means 26 is primarily forced into a closed position by the force of the pressurized fluid flow through the housing 12 and spring 57 which prevents the flow of fluid from passing out of the discharge port 24. Control means or trigger is provided for opening and closing the valve closure means 26.

A connecting rod 28 is affixed by suitable means such as a coupling sleeve 32 to the closure 26. The rod 28 is journaled to the inside of the housing at positions 33, 35 spaced apart on the inside of the housing to position the rod along the axis of the housing. At the terminal end 29 of the rod 28 a disc stop 46 is provided which holds a curved member 44 in place on the rod. The curved member paces through a vertical slot 43 in the control rod which allows vertical movement. When hand force is applied to the handle 40 it cause an upward force on the curved member 44 causing the valve closure 26 to separate from the seat and allow the passage of fluid out of the nozzle. When the pressure on the handle is released, the force of the fluid and spring 57 causes the rod 28 to return to its closed position so that the closure 26 fits tightly in the seat to shut off the flow of fluid from the nozzle.

The valve control means takes the form of a lever handle 40 extending at an inclined plane to the housing1 2. For delivery of the fluid the user manually depresses the lever handle 40. The delivery is accomplished by a curved member 44 which is an extension to the handle 40 and affixed to the handle at its end to slidably connected to the rod 28 extending to the closure 26. When the handle is depressed it causes the rod 28 to move longitudinally and disengage the closure 26 from its seat 16.

The handle 40 is cantilevered at a pivot point 42 adjacent to the end of the handle 40. When the control member 44 is forced downwardly it causes the control lever to force the rod 28 out of contact with the seat opening the housing to the flow of water. The handle 40 is provided with a stop 50 which when the handle 40 is totally depressed contacts the outside of the housing to prevent further downward movement.

The pivoting means 42 is preferably located near the end of the handle for a cantilevered effect and can be constructed of a series of two bracket sets 45, 46 having curved tops. The first set of brackets 45 are affixed to the outside of the housing 12 spaced apart to align with a similar set of two brackets 46 affixed in space relation to the lower side of the handle 40. A bolt 42 can pass through a hole provided in all of the brackets and serve as the pivoting point. The bolt 42 can easily be removed for disassembly of the unit.

As indicated the curved connecting member 44 passes into the inner chamber of the housing 12 through a resilient sleeve 56 such as synthetic rubber forming an extension of the housing 12. The passage is in such a manner as to prevent the passage of fluid and allow the necessary movement of the curved arm. For ease of assembly the rod 44 has a cut out portion 43 at its end to allow the curved rod to be slipped into the cutout and secured by the stop 46 and a bolt 54.

The coupling 52 can take any suitable form such as a typical hose coupling of mating screw threads.

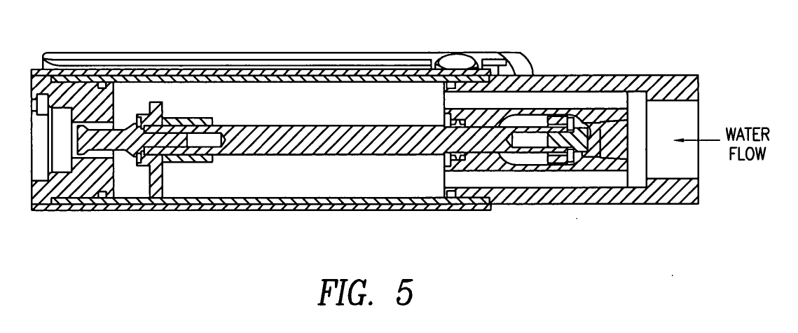

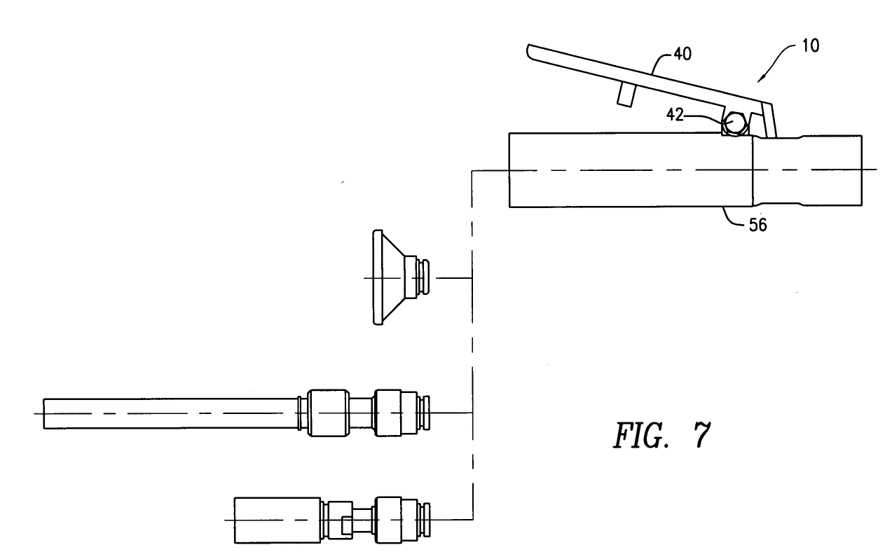

The invention is primarily intended for restaurants and the food preparation industry but it can also find use in other industries such as animal research. Referring to FIG. 5, illustrated are different type of discharge tools which can be affixed to the discharge end of the housing. One is a typical spray head, the second a spray wand and the third is a chisel head. These are just illustrative and other types of tools can be utilized.

It will occur to one of ordinary skill that still other modifications may be made to the disclosed embodiment. It is intended that the invention be defined by the appended claims and not by the description given herein which is given by way of example and not limitation.

From the foregoing, it can be seen that there has been provided a valve construction which has many advantages. The valves are constructed in such a manner that they can be readily inspected and cleaned. The valves particularly lend themselves to sanitary operations permitting cleaning and steam sterilization with the valves in place. The valves can be cleaned and steam sterilized without breaking the system once they are installed. Greatly improved sealing is achieved with the elastomeric boot because of its resiliency.

While the invention has been described in its preferred embodiment, it is to be understood that the words which have been used are words of description rather than limitation and that changes may be made within the purview of the appended claims without departing from the true scope and spirit of the invention in its broader aspects.

What is claimed is:

1. A straight flow nozzle comprising:
a housing through which fluid flows in a straight line,
the housing having a discharge port open to the ambient atmosphere for discharge of the fluid and an inlet port at opposite ends of the housing,
a coupling means secured to the inlet port for coupling a source of pressurized fluid to the housing,
a valve means located within the housing adjacent to the discharge port,
the valve means containing a valve seat and a closure means operating in combination,
the valve closure means being forced into a closed position against the valve seat by the force of the fluid within the housing, and
control means for opening the valve means to allow passage of fluid.

2. The straight flow nozzle as defined in claim 1 wherein the housing is a cyclical tube with a hollow core.

3. The straight flow nozzle as defined in claim 2 wherein the a housing is constructed of stainless steel.

4. The straight flow nozzle as defined in claim 1 wherein the discharge port contains coupling means for coupling spay devices to the nozzle.

5. The straight flow nozzle as defined in claim 4 wherein the inlet port contains coupling means to a source of pressurized fluid.

6. The straight flow nozzle as defined in claim 1 wherein the valve closure means comprises a trigger assembly having a handle pivotally affixed at one end of the outer surface of the housing to allow up and down movement.

7. The straight flow nozzle as defined in claim 6 wherein a member is affixed to the end of the handle which extends into the housing to engage a rod extending from the closure means to allowing opening of the valve.

8. The straight flow nozzle as defined in claim 7 wherein the downward movement of the handle causes the rod to move horizontally opening of the valve to allow the flow of pressurized fluid.

9. The straight flow nozzle as defined in claim 1 wherein the control means comprises a trigger assembly, the trigger assembly comprising an elongated handle for manual movement, the elongated handle being pivoted at one end with a pivot assembly affixed to the outside of the housing.

10. The straight flow nozzle as defined in claim 9 wherein the pivoted lever is associated with a rod within the housing which controls the valve closure means.

11. The straight flow nozzle of claim 1 wherein the housing bore extends along a longitudinal axis, the valve means comprising a valve seat secured in the bore, a movable valve member for engaging the seat, and a valve stem connected to the valve member for axially displacing the valve member into and out of engagement with the seat along said axis; and wherein the trigger comprises a trigger member pivotally secured to the housing and coupled to the stem for displacing the stem in response to pivoting of the trigger relative to the housing.

12. The straight flow nozzle as defined in claim 1 wherein the housing comprising a tubular member with a hollow bore extending along housing axis, the coupling means including a fluid receiving conduit depending from the housing transverse the axis and spaced from the trigger to form a fixed palm receiving handle for said nozzle.

13. The straight flow nozzle as defined in claim 12 comprising: a housing having a bore defining an axis; a valve seat in the bore at one bore end; a valve member in the bore for selectively engaging the valve seat for closing the valve in a direction along said axis; a stem in the bore secured to the valve member for operating the valve member and axially displaceable along the axis; a conduit coupled to the housing and bore including means for attachment to a source of fluid for supplying fluid to the housing, a trigger depending from and pivotally secured to the housing, the trigger including an axially displacing stem to open the valve in accordance with a selected trigger pivot position relative to the housing.

14. The straight flow nozzle as defined in claim 13 including a trigger guard member depending from the housing and cooperating with the conduit and housing for enclosing the trigger in a plane.

15. The straight flow nozzle as defined in claim 14 including a thermally conductive handle and thermally insulating means for insulating said housing and handle.

16. The straight flow nozzle as defined in claim 15 comprising: a housing having a pressurized fluid receiving bore; valve means for selectively opening the bore to the ambient atmosphere to eject pressurized fluid from the bore, said valve means including first bias means for biasing the valve means closed; trigger means including a trigger for selectively opening the valve means.

17. The straight flow nozzle as defined in claim 16 including trigger means for said selective opening of the valve means and further including trigger hold means having a normally disengaged state while the valve means is closed and an engaged state for holding the valve means open, said hold means for selectively releaseably holding the trigger means in the valve open state, said valve means including first bias means for biasing the valve means closed, said hold means comprising further bias means for biasing the trigger means in said normally disengaged closed valve state, said trigger means including means responsive to the first bias means for holding the trigger means in said valve open state while counteracting the bias of the further bias means.

18. A straight flow nozzle comprising:
a housing having a bore open at one end to the ambient atmosphere;
coupling means secured to the housing for coupling a source of pressurized fluid to the bore;
valve means in the bore adjacent to the one end having closed and open states for selectively opening and closing the one bore end for releasing pressurized fluid received in the bore to the ambient atmosphere through the bore end;
a trigger coupled to the valve means and housing and having a valve closed position and a range of valve open positions for placing the valve means in a selected open state in accordance with a given trigger position.

19. The straight flow nozzle as defined in claim 18, comprising:
a housing having a bore open at one end to the ambient atmosphere;
coupling means secured to the housing for coupling a source of pressurized fluid to the bore;
valve means in the bore adjacent to the one end having closed and open states for selectively opening and closing the one bore end for releasing pressurized fluid received in the bore to the ambient atmosphere through the bore end.
